(19) United States
(12) Patent Application Publication
(10) Pub. No.: US 2006/0175484 A1
(43) Pub. Date: Aug. 10, 2006

(54) Systems and methods for adjusting a stand

(76) Inventors: Robert A. Wood III, Lake Forest, CA (US); Rene F. Valbuena, Orange, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/127,541

(22) Filed: May 12, 2005

Related U.S. Application Data
(60) Provisional application No. 60/638,957, filed on Dec. 23, 2004.

(51) Int. Cl. F16M 11/02

(52) U.S. Cl. 248/177.1

(57) ABSTRACT

Embodiments of the disclosure include a stand, such as a tripod, including a deployment assembly for adjusting a height of the stand by, for example, adjusting a length of a telescoping tripod leg. In an embodiment, the deployment assembly adjusts the length of the tripod leg when the user actuates a control device, such as a trigger or a button. The control device may advantageously be located near the top of a tripod leg, which may facilitate leveling and/or heightening of the tripod. In addition, the deployment assembly may include a rack and gear assembly that controls relative movement of a lower leg segment with respect to an upper leg segment.

### RELATED APPLICATION

The present application claims the benefit of priority under 35 U.S.C. § 119(e) of U.S. Provisional Patent Application No. 60/638,957 filed on Dec. 23, 2004, entitled “TRIPOD HAVING AUTOMATIC DEPLOYMENT,” the entirety of which is hereby incorporated herein by reference.

### BACKGROUND OF THE INVENTION

1. Field of the Invention

The present disclosure relates to stands, such as stands for optical or photographic equipment. In particular, the present disclosure relates to systems and methods for adjusting the height of a stand.

2. Description of the Related Art

Stands, such as, for example, tripods, are often used for supporting optical or photographic equipment in a stable manner and generally include multiple legs attached to a platform for supporting such equipment. Many conventional tripods include a leveling display that indicates to the user when the tripod is in a substantially level position. To properly set up the tripod, a user generally adjusts the length of each tripod leg such that the platform is at a desired height and is substantially level. In adjusting the length of each tripod leg, the user manually locks an extendable leg segment of each leg into a fixed position through the use of screws or cam-type locking devices that squeeze or clamp the extendable leg segment.

In many conventional tripods, leg locking devices are usually located at a joint or coupling of two leg segments. For tripods having telescoping legs, the locking devices are positioned at the lower end of an upper leg segment. As a result, the user stoops or bends down to adjust the extendable segment (generally the lower segment) of each tripod leg even though the leveling display is often located on or near the platform at the top of the tripod (e.g., the apex at which the tripod legs meet). In so doing, the user is generally not able to easily view the leveling display while adjusting each leg. Thus, setting up and leveling conventional tripods can be an inconvenient and sometimes challenging task.

Furthermore, to adjust the length of telescoping tripod legs, the user generally secures the upper telescoping segment with one hand and the lower telescoping segment with the other hand while, at the same time, manually adjusting a mechanism that squeezes or clamps the lower segment. Such an adjustment process becomes more difficult when the tripod is relatively heavy, such as tripods used for supporting large telescopes or other similarly weighted equipment.

In response to at least some of the foregoing drawbacks, some tripods utilize a vertical central column that extends downward from the platform and that attaches to each tripod leg through connecting arms. The central column assists the user in establishing a desired height and angle among the legs. However, the central column increases the weight and complexity of the tripod, making the tripod more difficult to transport and/or disassemble. Moreover, the user generally still stoops or bends down to manually fine-tune the length of each tripod leg by using one of the aforementioned manual locking mechanisms.

### SUMMARY OF THE INVENTION

In view of the foregoing, conventional tripods do not provide the user with a straightforward way of adjusting the height of and/or leveling the tripod. In an embodiment, a tripod includes a straightforward way of adjusting its height, even when heavy or otherwise cumbersome equipment is already attached. In an embodiment, the tripod includes multiple adjustable-length legs, each of which is associated with a deployment assembly. The deployment assembly facilitates the process of adjusting the length of each tripod leg by allowing the user to level and/or heighten the tripod from a position near a platform of the tripod.

For example, in certain embodiments, the tripod includes a platform and multiple telescoping legs that each include an outer (upper) leg section and an inner (lower) leg section that slides within the outer leg section. Each of the telescoping legs is associated with a deployment assembly that controls movement of the inner leg section with respect to the outer leg section. The deployment assembly is associated with a control device, such as a trigger or a button, located near the top of the outer leg section and a locking mechanism that controls movement of the inner leg section. As the user adjusts or actuates the control device, the locking mechanism releases the inner leg section to allow for movement of the inner leg section with respect to the outer leg section.

For example, when the tripod is in a generally upright position, actuating the control device disengages the locking mechanism, thereby causing the inner leg section to slide out of the outer leg section due to, for example, gravitational force. This configuration advantageously allows the user to substantially automatically adjust the length of each tripod leg and, in various embodiments, at the same time, allows the user to view a leveling display located at the top of the tripod. In certain embodiments of the invention, the control device is located on the top of the outer leg section, on the platform, or on a leg receiver that couples the tripod leg to the platform.

In an embodiment, the deployment assembly comprises a rack and gear assembly. A ratchet lever selectively engages a rack gear on the inner leg section to control relative movement between the inner leg section and the outer leg section. The ratchet lever is operationally coupled through elongated linkage to a control device, which may be located, for example, near the top of the tripod leg or on the platform. When the tripod leg is in a fixed (non-extendable) configuration, the ratchet lever engages at least one of the teeth of the rack gear to substantially lock the inner leg section in place. When the user adjusts or actuates the control device, such as by actuating a trigger, the elongated linkage causes the ratchet lever to disengage from the rack gear and allows for movement of the inner leg section to adjust the overall length of the tripod leg.

In another embodiment, a method is disclosed for facilitating the adjustment of a leg of a stand, such as a tripod. In certain embodiments, a user secures and tilts, or cants, the stand such that at least one of the legs is lifted off a surface, such as the ground. During such tilting, at least two of the other legs of the stand advantageously remain in contact with the ground surface and support at least a portion of the weight of the tripod so that the user is not required to lift the entire tripod, and any attached equipment, off the ground. While the user is tilting the tripod, he or she then actuates a control device, such as a lever, that is located near the top of the stand. For example, the control device may be located toward the top portion of a leg or may be located near an attachment portion that secures the equipment. When the user actuates the control device, a locking mechanism is released and allows for relative movement between an upper leg portion and a lower leg portion of the first leg so as to adjust the length of the first leg. For example, gravitational pull on the leg may cause the lower leg portion to extend from the upper leg portion, or the user may lean the tripod such that the lower leg portion of the unlocked leg contacts the ground, or other surface, which causes the lower leg portion to slide toward the upper leg portion.

For purposes of summarizing the invention, certain aspects, advantages and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1 illustrates a perspective view of a tripod having an automatic deployment assembly according to one embodiment of the invention.

FIG. 2 illustrates an exploded view of a leg and a platform of the tripod of FIG. 1.

FIG. 3 illustrates a perspective view of an exemplary embodiment of a telescoping leg of the tripod of FIG. 1.

FIG. 4 illustrates an exploded view of the telescoping tripod leg of FIG. 3.

FIG. 5 illustrates a perspective view of an exemplary embodiment of an upper section of the telescoping tripod leg of FIG. 3.

FIG. 6 illustrates a perspective view of an exemplary embodiment of a leg receiver of the tripod of FIG. 1.

FIG. 7 illustrates an exploded view of the leg receiver of FIG. 6.

FIG. 8 illustrates an exploded view of an exemplary embodiment of a lower section of the telescoping tripod leg of FIG. 3.

### DETAILED DESCRIPTION OF THE PREFERRED EMBODIMENTS

Embodiments of the disclosure include a stand, such as a tripod, for mounting often heavy and/or cumbersome equipment, such as, for example, optical equipment, survey equipment, or the like. The tripod advantageously includes a deployment assembly providing for straightforward and efficient deployment of the tripod legs in light of the difficulty anticipated with mounting the equipment. In an embodiment, the tripod provides for telescoping legs, each comprising an outer section and an inner section slidable within the outer section. Moreover each leg includes a rack and gear assembly, actionable by a trigger, to adjust the length of each telescoping leg. When the trigger, is in an engaging position, a ratchet lever catches or contacts at least one tooth of the rack gear such that the inner section is substantially immobilized with respect to the outer section. When the trigger moves to a disengaged position, the inner section may slide out of, or into, the outer section, thereby adjusting the length of that leg of the tripod. In an embodiment, the rack and gear assembly can be biased in a locking position such that release of the trigger locks the leg section, or at least limits one direction of leg section movement, e.g., allowing lengthening but locking when weight is applied.

In a particularly advantageous embodiment, a user places the tripod on a surface, whereupon each telescoping leg is in a fixed position (such as, for example, a minimum length position). The user can then simply grasp the center platform, cant or lean the tripod onto two of its legs, and activate the trigger for the now substantially non-weight bearing leg. The trigger advantageously releases the ratchet lever, and by simply canting the platform back and forth, the inner section of the non-weight bearing leg will smoothly slide within the outer section of the non-weight bearing leg to lengthen (through for example, gravity) or shorten (through for example, reverse canting and applying partial weight) the leg. In one embodiment, the smooth sliding of the inner section within the outer section is facilitated by at least one bushing disposed between the inner section and the outer section and/or by the changes in air pressure within the chamber of the outer section, which changes may be caused by sliding of the inner section into and/or out of the outer section.

Furthermore, release of the trigger then locks the position of the leg section with respect to one another, and the user can then cant the tripod platform in a different direction to adjust the remain legs. Through the use of a conveniently positioned trigger mechanism, the user can fully adjust the height of the tripod from the platform position through the canting onto two of the legs. As will be recognized by an artisan from the disclosure herein, such canting allows for easy adjustment with or without potentially heavy equipment attached.

The features of the system and method will now be described with reference to the drawings summarized above. Throughout the drawings, reference numbers are re-used to indicate correspondence between referenced elements. The drawings, associated descriptions, and specific implementation are provided to illustrate embodiments and do limit the scope of the claims.

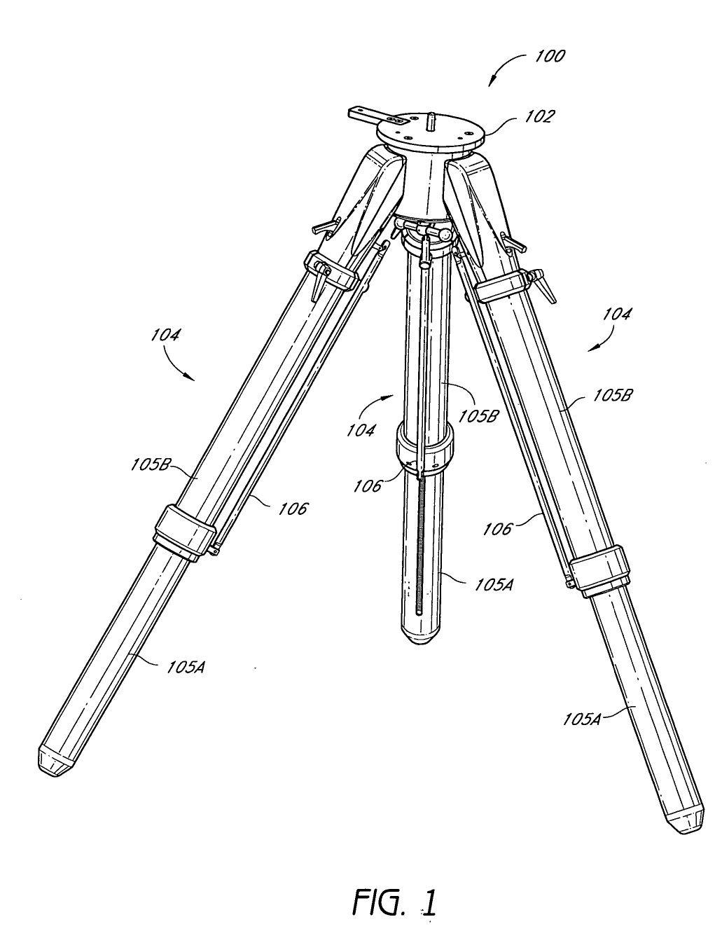

FIG. 1 illustrates a perspective view of a tripod 100 according to one embodiment of the invention. As shown, the tripod 100 includes a platform 102 for securing or supporting equipment. For example, the platform 102 may be configured to support or secure equipment such as a telescope, a camera, a movie camera, a sighting device, an electronic device, an audio device, surveying equipment, a rifle or other firearm, lighting fixtures, laser devices such as laser range finders, laser leveling equipment, laser surveying equipment, or the like. The platform 102 is generally shown as having a flat upper surface. In other embodiments, the platform 102 may comprise a curved or customized upper surface usable to attach or secure particular types of equipment.

The tripod 100 further includes a plurality of legs 104. As shown, the plurality of legs 104 comprise telescoping legs having multiple sections or segments 105A, 105B such that one section or segment 105A is capable of sliding within another section or segment 105B. Each leg 104 further includes a deployment assembly 106 associated therewith and usable to adjust the length of the leg 104. For example, the user may utilize the deployment assembly 106 to individually adjust each leg 104 such that the platform 102 is in a substantially level position.

The illustrated tripod 100 includes an adjustable height to accommodate the needs of the user. In an embodiment, the tripod 100 has a height of approximately 1.12 meters (3.67 feet) to approximately 1.42 meters (4.67 feet) when the legs 104 are in an extended position, and has a height of approximately 0.71 meters (2.33 feet) to approximately 1.02 meters (3.33 feet) when the legs 104 are in a retracted position. In other embodiments, the tripod 100 has a height greater than approximately 1.42 meters (4.67 feet) when the legs 104 are in an extended position, and/or a height less than 0.7 meters (2.33 feet) when the legs 104 are in a retracted position.

In an embodiment, the tripod 100 is capable of supporting heavy equipment, such as large telescopes. For example, the tripod 100 may be configured to support equipment of approximately 30 kilograms (66 pounds) to approximately 90 kilograms (200 pounds). For example, in an embodiment, the tripod 100 supports an ETX Maksutov-Cassegrain telescope or an RCX400 Advanced Ritchey-Chrétien telescope, each of which is commercially available from Meade Instruments Corp. of Irvine, Calif. In yet other embodiments, the tripod 100 is configured to support equipment having a weight greater than 90 kilograms.

In an embodiment, the tripod 100 is advantageously constructed of a lightweight material. In a preferred embodiment, portions of the tripod 100 are constructed of aircraft-grade 6061-T6 aluminum. In other embodiments, the tripod 100 comprises, for example, one or more of the following materials: aluminum, carbon fiber, carbon graphite, chromed steel, other composite materials or metals, metal alloys, combinations of the same, and the like. An artisan will also recognize from the disclosure herein a wide variety of materials suitable for the tripod 100, including materials or material combinations that balance manufacturing costs with performance and anticipated uses.

Although disclosed with reference to particular embodiments, the tripod 100 may include additional components or devices that enhance the functions or features of the tripod 100. For example, the tripod 100 may further include a leveling display located on or near the platform 102 that indicates to a user the relative position of the tripod 100. The tripod 100 may also include at least one connecting arm that attaches to at least one leg 104 to provide extra support and/or stability to the tripod 100 and/or the leg 104. Moreover, the tripod 100 may include a center post and linkages for initial positioning or the like.

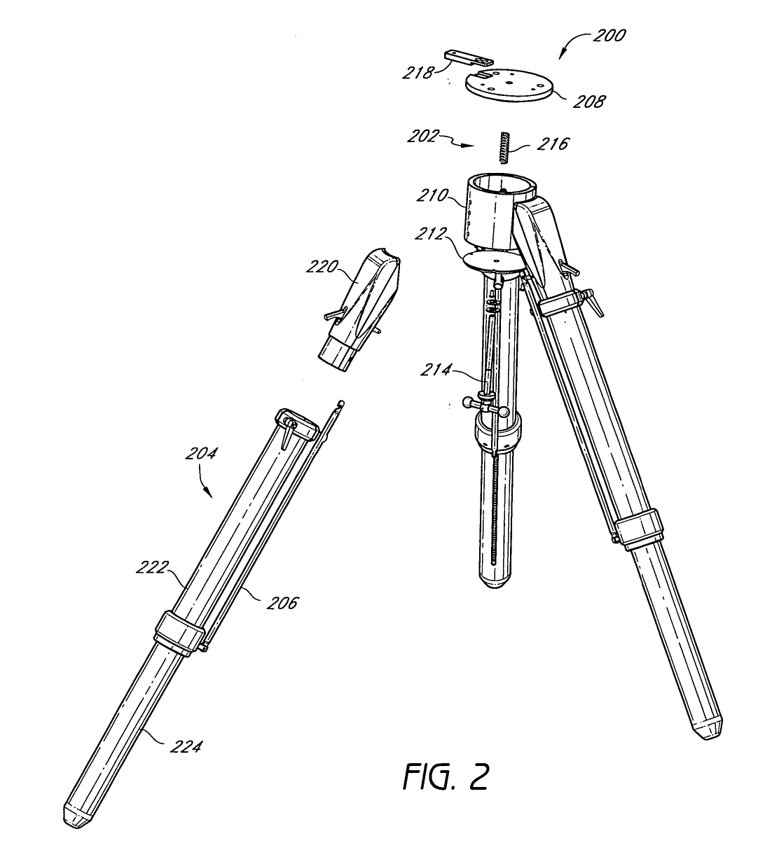

FIG. 2 illustrates an exploded view of a platform 202 and a leg 204 of a tripod 200. As shown, the platform 202 includes an upper plate 208, a platform body 210 and a lower plate 212. The illustrated upper plate 208 is disk-shaped and has a substantially planar top surface to accommodate or support different types of equipment.

The body 210 supports the upper plate 208 and accommodates coupling of the legs 204 to the platform 202. The illustrated tripod 200 further comprises a rotatable screw handle 214 that extends vertically through openings in the lower plate 212, the body 210, and the upper plate 208 of the platform 202. The upper end of the screw handle 214 is advantageously threaded such that the user may rotate the screw handle 214 to attach equipment to the platform 202. In particular, the threaded upper end of the screw handle 214 is configured to engage with a mounting hole, such as those commonly found on optical or photographic equipment usable with tripods.

As shown, the screw handle 214 is further associated with a compression spring 216 that adjusts the position of the screw handle 214. In particular, when no downward force is applied to the upper end of the screw handle 214 (e.g., no equipment placed on the platform 202), the spring 216 causes the upper end of the screw handle 214 to extend beyond the upper plate 208. However, when a downward force is applied to the upper end of the screw handle 214, the spring 216 compresses and the upper end of the screw handle 214 is partially or completely pushed into the upper plate 208.

In one embodiment, this spring loaded mounting assembly facilitates the mounting of heavy equipment onto the platform 202. In particular, the spring loaded handle assembly allows a user to set the heavy equipment onto the platform 202, thereby causing the upper end of the screw handle 214 to move flush with or below the upper plate 208. The user then slides the heavy equipment along the upper plate 208 until the mounting hole of the equipment is aligned with the upper end of the screw handle 214. Once the mounting hole is aligned with the screw handle 214, the spring 216 causes the upper end of the screw handle 214 to extend above the upper plate 208 and into the mounting hole. The user can then rotate the screw handle 214 to further secure the equipment to the platform 202.

Although disclosed with reference to particular embodiments, alternative configurations are usable with the screw handle assembly. For example, the upper end of the screw handle 214 may not have a threaded surface and may be configured to clip into or otherwise engage with a mounting hole of equipment to be supported by the tripod. In other embodiments, the screw handle assembly may include multiple handles or portions that engage the equipment. Moreover, an artisan will recognize from the disclosure herein that the platform 202 may advantageously include a wide variety of alternative or additional attachment mechanisms mechanically mateable with desired equipment. In an embodiment, such mechanisms may be interchangeable to provide for increased flexibility in the type of equipment that can be mounted on the tripod 200.

The illustrated platform 202 further includes an azimuth bar 218 usable to orient, adjust or otherwise secure the position of equipment used with the tripod 200. Additionally, the illustrated tripod 200 further includes a leg receiver 220 for coupling the leg 204 to the platform 202. The leg receiver 220, in particular, couples to an outer section 222 that, in turn, couples to an inner section 224 of the leg 204. The leg receiver 220 advantageously allows for removal of the leg 204 from the leg receiver 220. For example, when disassembling and/or transporting the tripod 200, a user may detach one or more of the legs 204 from their respective leg receivers 220. This facilitates transportation or storage of the tripod 200 by allowing for the tripod 200 to be disassembled into smaller, lighter-weight components.

The illustrated leg 204 includes the inner section 224 that is slidably connected to the outer section 222 of the leg 204. The leg 204 further includes a deployment assembly 206 for adjusting the length of the tripod leg 204.

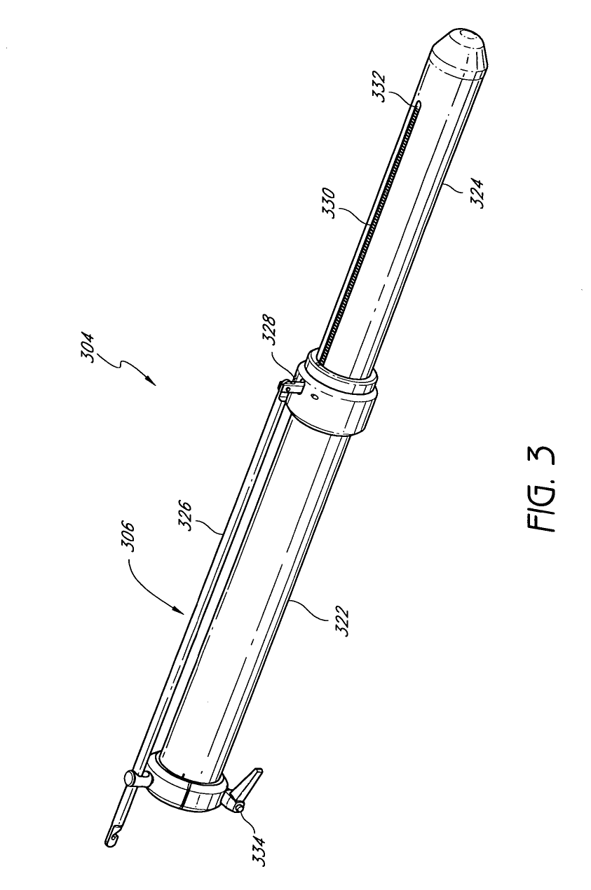

FIG. 3 illustrates a perspective view of a telescoping tripod leg 304 usable with the tripod 100 of FIG. 1. The illustrated tripod leg 304 includes an outer section 322 and an inner section 324, each of which has a generally tubular shape. The inner section 324 preferably has a diameter smaller than the diameter of the outer section 322 and is capable of sliding into and out of the outer section 322 to adjust the overall length of the tripod leg 304. In an embodiment, the diameter of the inner section 324 is between approximately 5.5 centimeters (2.17 inches) and approximately 8.05 centimeters (3.17 inches), and the diameter of the outer section 322 is between approximately 6.27 centimeters (2.47 inches and approximately 8.81 centimeters (3.47 inches).

In certain embodiments, the tripod leg 304 includes at least one bushing disposed between the inner section 324 and the outer section 322. The bushing may advantageously prevent the inner section 324 from unwanted lateral movement (e.g., movement in a radial direction with respect to the leg 304) within the outer section 322. In an embodiment, the bushing comprises a nylon bushing or like material. In other embodiments, other bushing materials or other devices, such as for example O-rings, may be used to substantially prevent or dampen unwanted lateral movement between the inner leg 324 and the outer leg 322.

Although the tripod leg 304 is disclosed with reference to particular embodiments, a skilled artisan will recognize from the disclosure herein a wide variety of alterative configurations usable with the tripod leg 304. For example, the tripod leg 304 may include more than two telescoping segments. In other embodiments, the relative positions of the outer section 322 and the inner section 324 may be reversed such that the upper portion of the tripod leg 304 (i.e., the portion nearer to the platform) slides into and out of the lower portion of the tripod leg 304. Furthermore, the tripod leg 304 may not be generally tubular shaped. For example, the tripod leg 304 may include an oval shape, a polygonal shape (e.g. triangular, rectangular), or the like. Moreover, an artisan will recognize from the disclosure herein that section diameters 322, 324 may be selected at least in part based upon the desire equipment to be mounted.

The illustrated tripod leg 304 further includes a deployment assembly 306 that controls the relative movement between the outer section 322 and the inner section 324 of the leg 304. The deployment assembly 306 includes elongated linkage 326 that extends generally along the outside surface of the outer section 322. The linkage 326 couples to a locking mechanism 328, such as a ratchet lever, usable to secure the inner section 324 in a substantially fixed position with respect to the outer section 322 of the leg 304. In particular, the ratchet lever 328 selectively engages a rack gear 330 located within a channel 332 of the inner section 324.

The rack gear 330 advantageously includes a plurality of teeth, or ridges, for engagement with the ratchet lever 328. In an embodiment, the teeth are spaced apart by a distance of approximately 0.50 millimeters (0.02 inches) to approximately 1.0 millimeters (0.04 inches). The teeth are preferably in a recessed position in the channel 332 such that the teeth do not extend beyond the circumferential surface of the inner section 324.

When the ratchet lever 328 is in an engaging position, the ratchet lever 328 catches or contacts at least one tooth of the rack gear 330 such that the inner section 324 is substantially immobilized with respect to the outer section 322. When the ratchet lever 328 moves to a disengaged position with respect to the rack gear 330, the inner section 324 may slide out of, or into, the outer section 322 of leg 304.

In one embodiment, the inner section 324 advantageously extends out of the outer section 322 when the ratchet lever 328 is disengaged and when the tripod log 304 is in, at least, a partially upright position (i.e., the inner section 324 having a lower position relative to the outer section 322). For example, the inner section 324 may advantageously comprise materials of sufficient weight that gravity causes the inner section 324 of the leg 304 to smoothly slide out of the outer section 324 until the movement of the inner section 324 is stopped or otherwise obstructed. For example, to stop the extension of the inner section 324, the user may re-engage the ratchet lever 328, the inner section 324 may reach its fully extended position, or the inner section 324 may contact the ground or other opposing surface. This allows the user to adjust the height of a tripod without having to manually grip or otherwise manipulate the inner section 324.

In certain embodiments, the tripod leg 304 advantageously provides for a smooth or dampened sliding movement between the inner section 324 and the outer section 322. For example, in an embodiment, the smooth movement is caused at least in part by changes in air pressure within the outer section 322. As the inner section 324 extends from the outer section 322, the amount of unoccupied space within the hollow outer section 322 increases. Because of the substantially tight fitting of the inner section 324 and the outer section 322 (such as, for example, from bushings, O-rings, or the like), the rate of air flow into and/or out of the outer section 322 (to compensate for movement of the inner section 324) is reduced. As a result, the sliding movement of the inner section 324 is dampened.

In certain embodiments, the user disengages the ratchet lever 328 by pulling the linkage 326 in a substantially upward direction. That is, as the user pulls the linkage 326 toward the top of the tripod leg 304, the linkage 326 causes the ratchet lever 328 to move away from the rack gear 330. In an embodiment, the user actuates a control device that, in turn, activates the linkage 326. For example, the control device may be advantageously located toward the top of the outer section 322 of the leg 304.

Although described with reference to particular embodiments, the deployment assembly 306 may include various alternative configurations usable to adjust the length of the tripod leg 304. For example, the deployment assembly 306 may be configured such that a pushing force applied to the linkage 326 in a substantially downward direction causes the ratchet lever 328 to disengage from the rack gear 330. In another embodiment, all or part of the deployment assembly 306 may be substantially encapsulated within the leg 304.

The illustrated tripod leg 304 further includes a clamping mechanism 334 usable to couple the outer section 322 to a leg receiver, a platform, another leg segment or other portion of a tripod. As illustrated, the user may manually adjust a lever of the clamping mechanism 334 to selectively loosen or tighten the grip of the clamping mechanism 334. In other embodiments, the clamping mechanism 334 may be located on the leg receiver or on other portions of the tripod instead of on the leg 304.

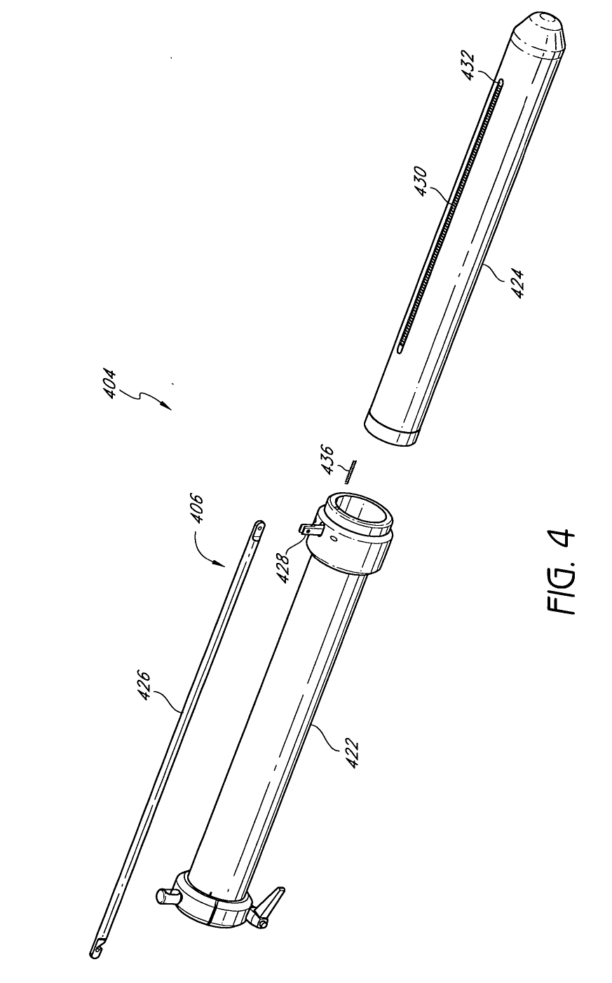

FIG. 4 illustrates an exploded view of a tripod leg 404 to show further details of a deployment assembly 406. In operation, the deployment assembly 406 controls or regulates the movement of an inner section 424 with respect to an outer section 422 of the leg 404 such that a user can adjust the overall length of the tripod leg 404. The deployment assembly 406 includes elongated linkage 426 coupled to a locking mechanism 428, such as a ratchet lever. As discussed above, the ratchet lever 428 selectively engages at least one tooth of a rack gear 430 to control movement of the inner section 424. In the illustrated embodiment, the rack gear 430 extends along a channel 432 recessed within the body of the inner section 424.

Further illustrated in FIG. 4 is a spring 436 associated with the locking mechanism 428. In one embodiment, the spring 436 causes the ratchet lever 428 to remain in an engaged position when no force is applied to the linkage 426. When a user applies a force to the linkage 426, the ratchet lever 428 disengages from the rack gear 430, applying an opposing force to the spring 436 and allowing the inner section 424 to move with respect to the outer section 422. When the user does not apply a force to the linkage 426, the spring 436 causes the locking mechanism 428 to automatically return to the engaging, or default, position, thus securing again the inner section 424 from movement.

Although the deployment assembly 406 is described with reference to particular embodiments, a skilled artisan will recognize from the disclosure herein a wide variety of alternative configurations usable with the deployment assembly 406. For example, the deployment assembly 406 may comprise a locking mechanism in the form of a clamping device, a rotatable ratcheting mechanism, a cam-type locking device, combinations of the same, or the like. Furthermore, the deployment assembly 406 may function without the linkage 426. For example, the user may directly or indirectly manipulate the locking device 428, such as, for example, by manually depressing the ratchet lever 428.

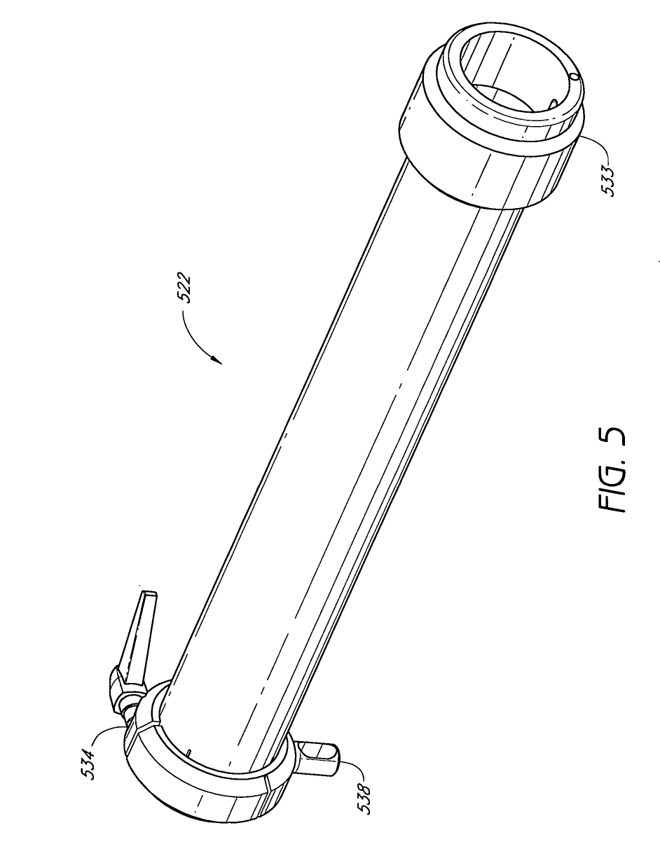

FIG. 5 illustrates an embodiment of an outer section 522 usable with the tripod 100 depicted in FIG. 1. The outer section 522 is generally tubular in shape and includes a lower end 533 configured to receive an inner leg portion, such as the inner section 424 depicted in FIG. 4. An opposite end of the outer section 522 includes a clamping mechanism 534 usable to secure the outer section 522 to a leg receiver or other tripod component. The outer section 522 also includes an eyelet 538 usable to secure or direct linkage extending therethrough, such as the elongated linkage 436 illustrated in FIG. 4.

As discussed above, in an embodiment, the outer section 522 comprises aircraft-grade 6061-T6 aluminum. In other embodiments, other materials suitable for tripod legs may be used.

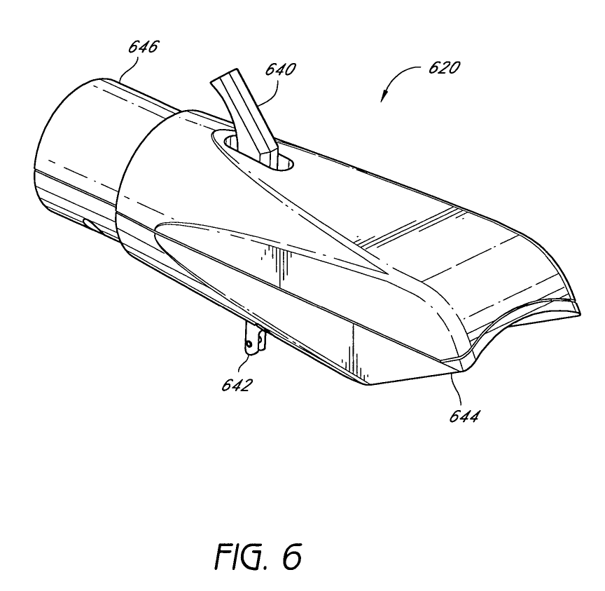

FIG. 6 illustrates a perspective view of an exemplary embodiment of a leg receiver 620 usable with a tripod, such as the tripod 100 illustrated in FIG. 1. As shown, the leg receiver 620 includes a control device 640, such as a trigger. The trigger 640 further includes a coupling end 642 usable to connect to linkage, such as the elongated linkage 426 depicted in FIG. 4.

In one embodiment, when the user depresses the trigger 640, the coupling end 642 pulls the linkage of the deployment assembly to disengage an associated locking mechanism, thereby allowing for adjustment of the length of the tripod leg. In other embodiments, the user may pull the trigger 640 to disengage the locking mechanism.

Although the control device 640 is disclosed with reference to particular embodiments, alternative devices or mechanisms may be used in place of a trigger. For example, the control device 640 may comprise a button, a lever, a switch, a knob, or the like usable to cause at least one locking mechanism to engage or disengage based on selections by the user. In another embodiment, the control device 640 causes multiple locking devices to disengage so that the user may adjust the length of multiple tripod legs at the same time.

The illustrated leg receiver 620 also includes an upper end 644 for coupling the leg receiver 620 to a platform or other component of a tripod. As shown, the upper end 644 advantageously includes an arcuately-shaped surface for facilitating attachment to a rounded platform. The upper end 644 may secure to the platform in a semi-permanent manner, such as through the use of screws and/or bolts, or may be releasably attached to the platform, such as through the use of clamps. Furthermore, the leg receiver 620 includes a lower portion 644 usable to couple the leg receiver 620 to a tripod leg.

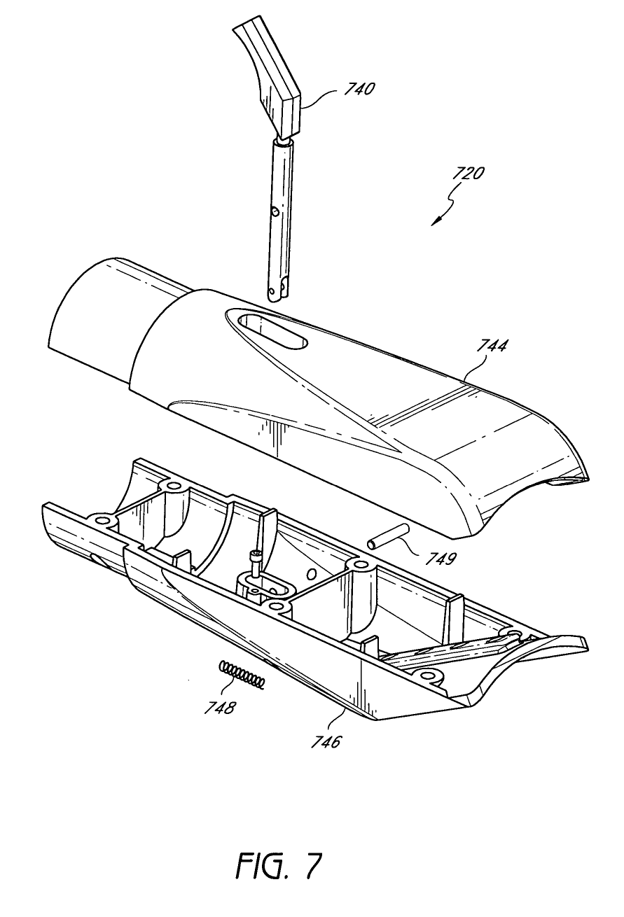

FIG. 7 illustrates an exploded view of an exemplary embodiment of a leg receiver 720. The leg receiver 720 includes an outside portion 744 and an inside portion 746 that form a housing of the leg receiver 720. As illustrated, a control device 740, such as a trigger, extends through the housing of the leg receiver 720. The control device 740 is further coupled to a spring 748. The spring 748 exerts a force on the control device 740 and causes the control device 740 to return to a neutral or default position when not actuated by a user. As shown, the control device 740 also pivots about a pivot pin 749 extending therethrough.

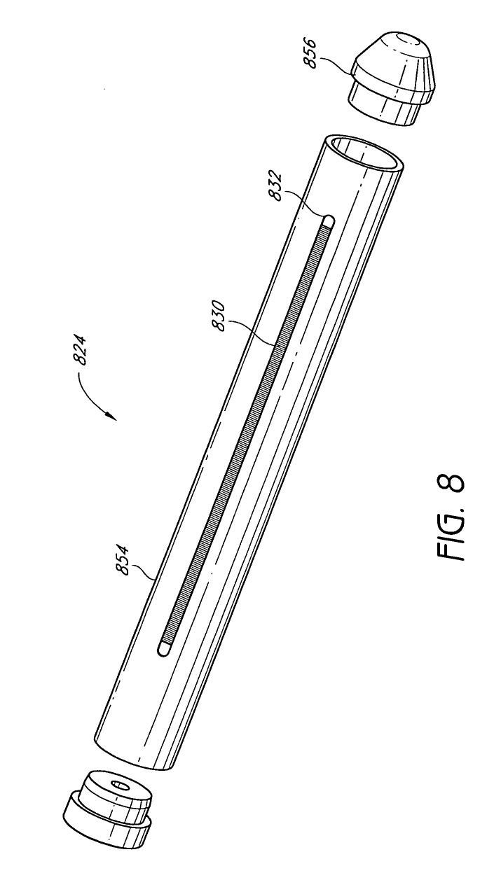

FIG. 8 illustrates an exploded view of an exemplary embodiment of an inner section 824. The inner section 824 generally comprises an elongated body 854, such as in the shape of a tube. A rack gear 830 extends along the length of the elongated body 854 and is situated in a recessed channel 832. The rack gear 830 advantageously includes a plurality of teeth configured to selectively engage a locking mechanism, such as the ratchet lever 328 depicted in FIG. 3.

Also depicted in FIG. 8 is a stopper 856 located at the bottom portion of the inner section 824. The stopper 856 advantageously comprises a material that prevents the tripod leg from slipping or moving during use. For example, the stopper 856 may comprise a rubber, a plastic, or other like material.

As shown, the inner section 824 is advantageously hollow to provide for a lighter weight tripod leg. In other embodiments, the inner section 824 may be substantially solid, or the inner section 824 may be configured to receive another leg segment.

Although the foregoing has been described in terms of certain preferred embodiments, other embodiments will be apparent to those of ordinary skill in the art from the disclosure herein. For example, the mechanical structures that operated with one another to perform one or more functions may be inverted, substituted for other mechanical mechanisms recognizable to a skilled artisan from the disclosure herein, automated or otherwise motorized, or the like. Moreover, a skilled artisan will recognize from the disclosure herein that the telescoping legs may include more than two sections.

In addition, while certain embodiments have been described, these embodiments have been presented by way of example only, and do not limit the scope of the claims. Indeed, the novel methods and systems described herein may be embodied in a variety of other forms; furthermore, various omissions, substitutions, and changes in the form of the methods and systems described herein may be made without departing from the spirit of the disclosure. The accompanying claims and their equivalents cover such forms or modifications as would fall within the scope and spirit of the disclosure.

What is claimed is:

1. A tripod for facilitating height adjustments, the tripod comprising:
a platform capable of supporting a piece of equipment;
a plurality of telescoping legs, wherein at least one of the telescoping legs further comprises:
an outer leg section configured to couple to the platform,
an inner leg section slidable with respect to the outer leg section to adjust the length of the at least one telescoping leg, and
a deployment assembly selectively movable between a first position and a second position, wherein the deployment assembly in a first position is capable of substantially preventing sliding movement between the inner leg section and the outer leg section, and wherein the deployment assembly in a second position is configured to allow for sliding movement between the inner leg section and the outer leg section; and
a control device located closer to the platform than an opposite end of the outer leg section and coupled to the deployment assembly, wherein the control device is configured to switch the deployment assembly between the first position and the second position.

2. The tripod of claim 1, wherein the platform comprises a plurality of leg receivers and the outer leg section is configured to couple to one of the plurality of leg receivers.

3. The tripod of claim 2, wherein the control device is located on at least one of the plurality of leg receivers.

4. The tripod of claim 1, wherein the platform is sized to hold at least one of a telescope, survey equipment, a camera, a movie camera, a sighting device, an optical device, an electronic device, and an audio device.

5. The tripod of claim 1, wherein the deployment assembly is coupled to the outer leg section.

6. The tripod of claim 1, further comprising a spring-loaded handle assembly capable of securing the piece of equipment to the platform.

7. The tripod of claim 1, wherein the control device comprises a trigger.

8. The tripod of claim 1, wherein the control device comprises a button.

9. The tripod of claim 1, wherein the telescoping legs comprise aluminum.

10. A stand having an assembly for adjusting the length of a leg, the stand comprising:
an attachment portion capable of securing a piece of equipment;
a plurality of adjustable legs, each of the adjustable legs comprising an upper leg portion and a lower leg portion, each upper leg portion having a first end connected to the attachment portion and a second end, each lower leg portion being movable with respect to the upper leg portion to lengthen the adjustable leg; and
an assembly connected to at least one adjustable leg and capable of regulating the movement between the lower leg portion and the upper leg portion, the assembly further comprising:
a locking mechanism capable of substantially preventing relative movement between the lower leg portion and the upper leg portion, and
a control device operationally coupled to the locking mechanism and configured to cause the locking mechanism to alternatively allow and substantially prevent relative movement between the lower leg portion and the upper leg portion, wherein the control device is located proximate the first end of the upper leg portion.

11. The stand of claim 10, wherein the attachment portion comprises a spring-loaded handle assembly capable of securing the piece of equipment to the stand.

12. The stand of claim 10, wherein the upper leg portion is removably connected to the attachment portion.

13. The stand of claim 10, further comprising linkage coupling the control device to the locking mechanism.

14. The stand of claim 10, wherein the locking mechanism comprises a ratchet lever capable of selectively engaging a rack gear on the lower leg portion.

15. The stand of claim 10, wherein the plurality of adjustable legs comprises three legs and the stand comprises a tripod.

16. A method for adjusting a leg of a tripod, the method comprising:
tiling a tripod such that a first leg of the tripod is elevated off a surface and such that a second leg and a third leg of the tripod are in contact with the surface and bear at least a portion of the weight of the tripod; and
actuating a control device located near a top of the tripod, wherein actuating the control device allows for relative movement between an upper portion and a lower portion of the first leg to adjust a length of the first leg.

17. The method of claim 16, wherein said relative movement comprises telescoping movement.

18. The method of claim 17, wherein said relative movement is caused at least in part by the weight of the lower portion such that the lower portion partially extends from within the upper portion.

19. The method of claim 16, wherein actuating the control device comprises releasing a locking mechanism.

20. The method of claim 19, wherein releasing the locking mechanism comprises disengaging a lever from a rack gear.

21. The method of claim 16, additionally comprising releasing the control device to cause the locking mechanism to re-engage and prevent substantial movement between the upper portion and the lower portion.

22. A stand having an assembly for adjusting the length of at least one of a plurality of legs, the stand comprising:
means for securing a piece of equipment;
a plurality of means for supporting the means for securing, each of the plurality of means for supporting having an upper portion and a corresponding lower portion; and
means for regulating relative movement between at least one upper portion and the corresponding lower portion, the means for regulating further comprising actuating means for controlling the relative movement, wherein the actuating means is located proximate the means for securing.
